(19) United States
(12) Patent Application Publication
(10) Pub. No.: US 2012/0101246 A1
(43) Pub. Date: Apr. 26, 2012

(54) Epoxy Resin, Method for Producing Same and Epoxy Resin Composition Thereof

(75) Inventors: Masayoshi HANAFUSA, Chiyoda-ku (JP); Shuya SHINOHARA, Sodegaura-shi (JP); Chongsoo PARK, Seoul (KR); Kyungho Park, Seoul (KR); Deuk-sung BAE, Seoul (KR); Seok LEE, Seoul (KR)

(73) Assignee: KUKDO CHEMICAL CO., LTD. (KOREAN CORPORATION), Seoul (KR)

(21) Appl. No.: 13/279,510

(22) Filed: Oct. 24, 2011

Related U.S. Application Data
(63) Continuation-in-part of application No. 12/491,548, filed on Jun. 25, 2009, now abandoned.
Application No. 12/491,548 is a continuation-in-part of application No. 11/629,688, filed on Dec. 14, 2006, now abandoned.

(30) Foreign Application Priority Data
Jun. 17, 2004 (JP) JP2004/179177

(51) Int. Cl. C08G 59/06

(52) U.S. Cl. 528/95

(57) ABSTRACT

An epoxy resin represented by general formula (I) satisfying numerical formula (1) with hydrolytic halogen of 0.05 wt. % or less, said epoxy resin produced as follows: after dissolving 0.8 to 1.3 mole of epihalohydrin to 1 mole of divalent phenol in a solvent, a pre-reaction is performed over 30 to 70 minutes by adding dropwise 0.25-0.35 mole of 30˜50% aqueous solution of alkali metal hydroxide over 30 to 70 minutes thereto, and thereafter, 0.65-0.75 mole of the remaining 30˜50% aqueous solution of alkali metal hydroxide is added dropwise over about 1 hour to complete the reaction over 1 to 3 hours.

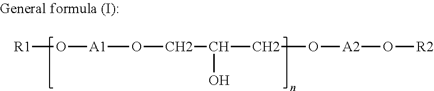

0.5≦X/Y≦1.5 Numerical formula (1)

This application is being filed as a continuation-in-part of Ser. No. 12/491,548, which was filed on Jun. 25, 2009.

### FIELD OF THE INVENTION

The present invention relates to a half-capped epoxy resin in which a phenolic hydroxyl group is chemically bonded to an epoxy group at an end thereof, a method for preparing the epoxy resin, and an epoxy resin composition containing the epoxy resin. More in detail, the present invention relates to a thermosetting epoxy resin which indicates thermosetting property mainly based on a reaction between an intramolecular epoxy group and a phenolic hydroxyl group characterized by further improving chemical and physical characteristics which conventional epoxy resin cured product has, and a method for production of said epoxy resin, further relates to an epoxy resin composition containing said epoxy resin.

### DESCRIPTION OF THE PRIOR ART

Epoxy resin is widely used for various uses such as coating, electrical use, civil engineering use or adhesive because of its excellent chemical and physical characteristics. For example, in a coating field, excellent adhesion with a coated product, corrosion resistance, toughness and impact resistance are required, however, in combination of a conventional epoxy resin with a public known curing agent, for example, dicyandiamide, hydrazide such as dihydrazide adipate, acid anhydride, dibasic acid or polyester with acid end has a limitation when used in severe environment, such as under ground laid gas transporting pipe, epoxy coated iron code or iron wire which is required to be bended after coated or under surface use for car. As a composition to endure such a requirement, a composition prepared by blending bisphenol A phenolic curing agent to bisphenol A epoxy resin is disclosed in Patent Document A, and said composition is characterized to improve its property remarkably so as to be used to outer surface coating of a pipe. As such phenolic curing agent, a compound which is prepared by reacting stoichiometric excess bisphenol A to an epoxy resin having relatively lower molecular weight can be mentioned, and for example, “EPOTOHTO ZX-767” or “EPOTOHTO ZX-798P” which are products of Tohto Kasei Co., Ltd., “EPICURE-171” which is a product of Japan Epoxy Resin Co., Ltd., or “DEH-81” which is a product of Dow Chemical Co., Ltd., are on the market. Although these compounds are industrially useful phenolic curing agents, however, it is necessary to produce epoxy resin and phenolic curing agent separately and to control their quality respectively. Further, in the production of cured composition using these compounds, mixing process of these components is necessary, and according to a mixing method, uniform composition can not be expected and sometimes cured product having desired characteristic can not be obtained. Especially, in a case of production of powder coating, an epoxy resin and a curing agent such as phenolic curing agent, wherein molecular weight and softening point of these compounds are different, are blended and becomes apparently uniform by melting and kneading process, however, obtained powder coating is sometimes uneven in mixing of epoxy resin and curing agent, and defects of coated film caused by said uneven mixing condition are observed, that is, properties such as corrosion resistance, impact resistance or flexibility are not performed. As a countermeasure to avoid above mentioned phenomenon, a method to melt and knead the mixture again and to mix the epoxy resin and the curing agent more uniformly is carried out. However, said multiple melting and kneading process is not desirable, because partially gel product is formed and is not desirable. Further, since producing process becomes complicated, said method is disadvantageous from industrial view point. Therefore, development of a composition which contains an epoxy resin and a curing agent uniformly by molecular level is desired.

In the meanwhile, as a resin which contains an epoxy resin and a phenolic hydroxide group uniformly by molecular level, a method to obtain a composition by polyaddition reaction of epoxy resin of lower molecular weight with bisphenol under the presence of alkali metal catalyst is proposed in Patent Document 2. However, in this method, alkali metal catalyst can not be removed from the product, accordingly has a problem in preservative stability of resin. Further, in this method, since controlling of end point of reaction is difficult, it is difficult to obtain same quality resin stable. Furthermore, this method is characterized to produce epoxy resin of lower molecular weight as the first step, then react said resin with bisphenol, and differs from the present invention which is characterized to be synthesized directly from divalent phenol and epihalohydrine. Still further, process of said method of Patent Document 2 is complicated and is disadvantageous from industrial view point.
Patent Document 1: JPA S54-7437 publication
Patent Document 2: JP 2654796 publication
Patent Document 3 U.S. Pat. No. 4,355,122 Publication

Meanwhile, Patent Document 3 discloses a method for preparing an epoxy resin by reacting 0.985 to 1.015 moles of epihalohydrine with 0.6 to 1.5 moles of an alkali metal hydroxide, with respect to one mole of divalent phenol. The epoxy resin prepared by this reaction is a di-functional epoxy resin having only a hydroxyl (—OH) group at an end thereof. This resin is different from the product of the present invention having both an epoxy group and a phenolic hydroxyl (—OH) group in an epoxy molecule, in that it is a phenoxy (or semi-phenoxy) resin typically having a polymerization degree (n) of 30 to 80. The phenoxy resin can be prepared by a process in which an ECH/BPA molar ratio is one to one as a completely stoichiometric ratio (so-called “Taffy process”:1-step reaction). However, this one-step process has a problem of difficult control of reaction. Accordingly, the phenoxy resin is generally prepared by firstly preparing epoxy as an intermediate and increasing a molecular weight thereof using the epoxy (Taffy process+fusion process: 2-step reaction). The phenoxy resin is different from the product of the present invention in terms of curing method and characteristics and applications. The molar ratio (ECH/BPA molar ratio: 1.015 to 0.985) of U.S. Pat. No. 4,355,122 is wider than a molar ratio of actual preparation. This preparation method is similar to the preparation method of the present invention, but the prepared final resin of the US patent is distinguished from that of the present invention.

Accordingly, the object of the present invention is to make contain component of curing agent, in particular, phenolic curing agent component by molecular level in epoxy resin. More in detail, the object of the present invention is to provide curable resin possessing an epoxy group, which is synthesized directly from divalent phenol and epihalohydrine, and phenolic hydroxyl group, and to provide a method for production of same, further to provide epoxy resin composition thereof.

### BRIEF DESCRIPTION OF DRAWINGS

FIG. 1 is HPLC chart of epoxy resin (B) obtained in Example 1,

FIG. 2 is HPLC chart of epoxy resin; EPOTOHTO YD-014 of Comparative Example 3,

FIG. 3 is FD-MS spectrum of Epoxy resin (B) obtained in Example 1,

FIG. 4 is FD-MS spectrum of epoxy resin; EPOTOHTO YD-014 of Comparative Example 3, abscissa of FIGS. 1 and 2 indicates elusion time and ordinate indicates absorbency. Abscissa of FIGS. 3 and 4 indicates mass number m/z and ordinate indicates intensity of peak. Further, a group, b group and c group mentioned in FIGS. 3 and 4 indicate that A₁ and A₂ in general formula (I) are residue from which hydroxyl group of bisphenol A is removed, in a group, both R₁ and R₂ are

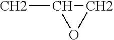

in b group, both R₁ and R₂ are H (hydrogen atom).
in c group, one of R₁ or R₂ is

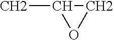

and another one is H (hydrogen atom).

### DISCLOSURE OF THE INVENTION

The essential point of the present invention is epoxy resin represented by following general formula (I), which is synthesized from divalent phenol and epihalohydrine, and satisfies numerical formula (1) mentioned below, further, amount of hydrolytic halogen is 0.05 wt. % or less, and a method for production of same and epoxy resin composition thereof

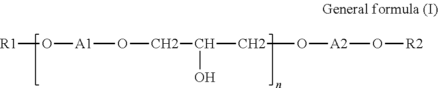

wherein n is a integer of 0 or more.

A₁ and A₂ are residue of divalent phenol, and A₁ and A₂ can be same or can be different.

both R₁ and R₂ are H or

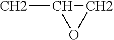

0.5≦X/Y≦1.5 Numerical formula (1)

wherein, X: epoxy equivalent (g/eq), Y: phenolic hydroxyl group equivalent (g/eq)

### DESCRIPTION OF THE PREFERRED EMBODIMENT

As a method for production of epoxy resin which possesses both epoxy group and phenolic hydroxyl group of the present invention, a method to react 1.03 to 1.10 mole of epihalohydrin to 1 mole of divalent phenol under the presence of metal hydroxide can be mentioned. As a divalent phenol, bisphenol A, bisphenol F, bisphenol S, tetrabromobisphenol A, bisphenol AD, bisphenol C, catechol, resorcin, hydroquinone or mixture thereof can be mentioned, and among these compounds bisphenols is desirable. As epihalohydrin, epichlorohydrin, epiiodohydrin, epibromohydrin, methylepichlorohydrin, methyl epibromohydrin or methylepiiodohydrin can be mentioned, and among these compounds epichlorohydrin is desirable.

In the reaction of divalent phenol with epihalohydrine, one mole of divalent, phenol reacts with 1.03 to 1.10 moles of epihalohydrine. When epihalohydrin is smaller than 1.03 mole, amount of phenolic hydroxyl group in obtained epoxy resin becomes larger than necessary amount and curability is remarkably deteriorated, therefore is not desirable. That is, value of numerical formula (1) exceeds upper limit 1.5 and curability is remarkably deteriorated, therefore, is not desirable. Further, when epihalohydrin is larger than 1.10 mole, amount of phenolic hydroxyl group in obtained epoxy resin becomes too small and curability is also remarkably deteriorated, therefore, is not desirable. That is, since the lower limit in formula I is lower than 0.5, curability is disadvantageously considerably deteriorated.

As an alkali metal hydroxide to be existed at the reaction of epihalohydrin with divalent phenol, sodium hydroxide, potassium hydroxide, lithium hydroxide or mixture thereof can be mentioned, and it is desirable to be used as aqueous solution, further aqueous solution of sodium hydroxide is more desirable. Such alkali metal hydroxide functions as a catalyst to ionize —OH group on the terminus of divalent phenol to so that epihalohydrin can be easily reacted with divalent phenol.

Total amount of alkali metal hydroxide that is used at reaction and refining process is desirably 0.98-1.05 mole to 1 mole of epihalohydrin. More desirably, is 1.00-1.03 mole. When total amount of alkali metal hydroxide is smaller than 0.98 mole, reaction between divalent phenol and epihalohydrin does not progress easily and large amount of hydrolytic halogen remains, while, when total amount of alkali metal hydroxide exceeds 1.05 mole, high molecular weight compound is formed and controlling of reaction becomes difficult.

Reaction between epihalohydrin and divalent phenol can be carried out in solvent which does not react with epoxy group, specifically, aromatic hydro carbons such as toluene, xylene or benzene, ketones such as methylisobuthyl ketone, methylethyl ketone, cyclohexanone or acetone, alcohols such as propanol or buthanol, glycolethers such as diethy leneglycolmethylether, propyleneglycolmethylether or dipropyleneglycolmethylether, aliphaticethers such as diethylether, dibutylether or ethylpropylether, alicyclicethers such as dioxane or tetrahydrofurane can be mentioned, and these compounds can be used or can be used by mixing. During the reaction, weight parts of these solvents is 10-200 weight parts to 100 weight parts of divalent phenol, desirably 50-100 weight parts to 100 weight parts of divalent phenol.

The reaction can be carried out by dissolving divalent phenol, epihalohydrine and a solvent in a reaction vessel and then adding dropwise an aqueous solution of alkali metal hydroxide at 70-100□ under normal pressure. When the reaction temperature is lower than 70.□, progress of reaction becomes not easy, while, when the reaction temperature exceeds 100.□, there is a dangerous possibility that epihalohydrine distil out to the outside, and is not preferable. At this time, the aqueous solution of alkali metal hydroxide should be added dropwise in two steps as two separate fractions. That is, after dissolving divalent phenol, epihalohydrine and the solvent, a pre-reaction is performed by adding dropwise 0.25-0.35 mole of 30˜50% aqueous solution of alkali metal hydroxide over 30 to 70 minutes thereto. Thereafter, 0.65-0.75 mole of the remaining 30-50% aqueous solution of alkali metal hydroxide is added dropwise over about 1 hour to complete the reaction over 1 to 3 hours.

The reason to separate the whole reaction into the pre-reaction and main reaction is to stably yield the product of a structure having phenolic —OH group on one terminus and epoxy group on the other terminus (i.e., n=0 in the general formula (I)) before obtaining the product having a structure of relatively high molecular weight (i.e., n=1 in the general formula (I)). As such, according to the present invention, the epoxy resin of claim 1 having both a phenolic hydroxyl (—OH) group and an epoxy group in one molecule can be prepared by suitably controlling a reaction molar ratio of epihalohydrine and bivalant phenol, an alkali metal hydroxide as a catalyst and reaction conditions.

Thus the reaction can be ended, however, in a case that the amount of hydrolytic halogen is too much, refined epoxy resin of the present invention can be obtained by following process. That is, after alkali metal hydroxide is added in above mentioned maximum amount so as to carry out re-ring-closing reaction at 60-90.0 for 10 minutes to 2 hours, remove excess alkali metal hydroxide or by-product salt by neutralization or washing by water, then remove solvent by vacuum distillation.

Properties of epoxy resin of the present invention which is obtained as above is desirably characterized as to be X/Y is 0.5 or more and 1.5 or less. More desirably, is to be 0.6 or more and 1.2 or less. When X/Y is smaller than 0.5, amount of phenolic hydroxyl group to epoxy group is very few, and is not desirable because curing tendency is deteriorated. When X/Y exceeds 1.5, amount of phenolic hydroxyl group to epoxy group is surplus, and is not desirable because curing tendency is also deteriorated. Further, content of hydrolytic halogen is desirably 0.05 weight % or less. When the content of hydrolytic halogen is over than 0.05 weight %, curing reaction is prevented in a case of composition which uses a basic curing accelerator and consequently properties of cured product is deteriorated and therefore is not desirable. Still further, it is desirable that epoxy equivalent is 3000 g/eq or less and phenolic hydroxyl group equivalent is 5000 g/eq or less. More desirably, epoxy equivalent is 2500 g/eq or less and phenolic hydroxyl group equivalent is 3000 g/eq or less. When epoxy equivalent is larger than 3000 g/eq and phenolic hydroxyl group equivalent is 5000 g/eq, molecular weight becomes too high and is difficult to produce or density of epoxy group and phenolic hydroxyl group becomes to small and properties of cured product is deteriorated and therefore is not desirable.

0.5≦X/Y≦1.5 Numerical formula (1)

wherein, X: epoxy equivalent (g/eq), Y: phenolic hydroxyl group equivalent (g/eq)

The epoxy resin composition of the present invention is an epoxy resin composition which contains the epoxy resin of the present invention as an essential component. The epoxy resin of the present invention self-cures using the same curing accelerator as a conventional epoxy resin composition without any particular curing agent.

As a curing accelerator, a curing accelerator which is generally used in a curable composition of epoxy resin is usable, for example, amines such as diethylenetriamine, trietylenetetramine, isophoronediamine, methaxylenediamine or diaminodiphenylmethane, imidazoles such as 2-methylimidazole or 2-ethyl-4methylimidazole, imidazolines such as 2-methylimidazoline or 2-ethyl-4-methylimidazoline, various salts such as triazine salt, cyanoethyl salts or cyanoethyl trimellitate of imidazole compounds, metallic compounds such as sodium acetate, quaternary ammonium salt such as tetraethylammoniumchloride, amide compounds or organic phosphorus compounds such as triphenylphosphine can be mentioned. Blending ratio of these is 0.01-5 weight parts desirably 0.1-2 weight parts to 100 weight parts of epoxy resin of the present invention.

To the epoxy resin composition of the present invention, conventional epoxy resins or curing agents can be blended besides above mentioned curing accelerators if necessary. As an epoxy resin, for example, diglycidilethers of bisphenol such as bisphenol A or bisphenol F, novolac polyglycidilethers such as phenol novolac or cresol novolac, polyglycidilester such as hexahydrophthalic acid or dimeric acid, polyglycidilethers of alcohols such as polyethylene glycol or polypropylene glycol, polyglycidilamines such as diaminodiphenylmethane or alycyclic epoxy resin can be mentioned. These compounds can be used alone or can be used by mixing. As a curing agent, a compound which is generally used as a curing agent for epoxy resin can be used. For example, amines such as diethylenetriamine, toriethylenetetramine, isophoronediamine, metaxylenediamine or diaminodiphenylmethane, acid anhydride such as phthalic anhydride, hexahydrophthalic anhydride, nadic anhydride or torimellic anhydride, polyester resin with acid functional end group, polyaminoamide resin which is a condensation product of dimeric acid with diethylenetriamine or triethylamine, polysulfide resin having mercaptan group at an end, boron trifluoride complex, novolac resin obtained by condensation reaction of phenols and formalin, various compounds possessing phenolic hydroxyl group, organic acid dihydrazide such as dihydrazide sebacate, polyisocyanates, resolplienolic resin or amine resin can be mentioned. These compounds can be used alone or can be used by mixing.

To the epoxy resin composition of the present invention, filler, pigment, diluent or other reforming agent can be used if necessary. The epoxy resin compound of the present invention is fitted to an use for a coating such as anticorrosion coating, powder coating, PCM coating or can coating, an use for construction, an use for an adhesive, an use for an electrical insulator, an use for an electric or electronic parts such as virtual fixing agent for a semi conductor chip or an use for various composite materials such as laminated board (printed circuit board) or carbon fiber reinforced plastic (CFRP).

### EXAMPLES

The present invention will be illustrated more in detail according to following Examples, however, not intending to restrict the scope of claims by Examples. In Examples and Comparative Examples, parts for blending of each component indicates weight parts.

Epoxy equivalent is measured by a method prescribed in JIS K-7236.

Phenolic hydroxyl group equivalent is measured by following method. In mixed solution of 96 weight % of tetrahydrofuran and 4 weight % of methanol, tetramethylammoniumhydroxide is acted to phenolic hydroxyl group and develop color and absorbance at 305 nm wavelength is measured using a spectrophotometer. Phenolic hydroxyl group equivalent is calculated using a calibration curve which was previously prepared by using divalent phenol, which is used as a starting material, as a standard component by same procedure.

Amount of hydrolytic chlorine is measured by following method. Approximately 2 g of specimen is weighted and placed into a conical flask, then dissolved in dioxane, after that, 25 ml of 0.1N-KOH methanol solution is added and reacted in warm water of 70.□ for 30 minutes. Then the contents is transported to 200 ml beaker and acetone, DI water, 3 ml of acetic acid are added. After that, amount of hydrolytic chlorine is measured by potentiometric titration using 0.01N-AgNO aqueous solution.

### Example 1

To a reactor to which a stirrer, a thermometer, a nitrogen blowing tube and a cooling tube are equipped, 228 parts (1.0 mole) of bisphenol A as divalent phenol, 102 parts (1.1 mole) of epichlorohydrine and 200 parts of methylisobutyl ketone are added and dissolved at 40.□, then 25 parts (0.30 mole) of 48.5% NaOH aqueous solution is dropped by 30 minutes, then preliminary reaction is carried out at 70.□ for 1 hour. Further, 67 parts (0.81 mole) of 48.5% NaOH aqueous solution is dropped by 1 hour, then reacted at 90.□ for 3 hours. After that, 350 parts of methylisobutylketon and 250 parts of water are added and dissolved, then the reactor is stood and water layer is removed. Neutralized by phosphoric acid, washed by water and water layer is removed. After washed by water again and filtrated, methylisobutyl ketone is distilled off. Thus epoxy resin (A) of the present invention is obtained. Properties are summarized in Table 1. As a result of analysis of this resin, an epoxy equivalent was 990 g/eq, a phenolic hydroxyl group equivalent was 1,600 g/eq, and hydrolytic chlorine was 0.01 wt %.

### Example 2

To a reactor to which a stirrer, a thermometer, a nitrogen blowing tube and a cooling tube are equipped, 228 parts (1.0 mole) of bisphenol A as divalent phenol, 97 parts (1.05 mole) of epichlorohydrine and 200 parts of methylisobutyl ketone are added and dissolved at 40.□, then 25 parts (0.30 mole) of 48.5% NaOH aqueous solution is dropped by 1 hour, then preliminary reaction is carried out at 90.0 for 3 hours. Further, 57 parts (0.69 mole) of 48.5% NaOH aqueous solution is dropped by 1 hour, then reacted at 90.□ for 3 hours. After that, 350 parts of methylisobutylketon and 250 parts of water are added and dissolved, then the reactor is stood and water layer is removed. 4.1 parts (0.05 mole) of 48.5% NaOH aqueous solution is further dropped and reacted at 80.□ for 1 hour. Neutralized by phosphoric acid, washed by water and water layer is removed. After washed by water again and filtrated, methylisobutyl ketone is distilled off. Thus epoxy resin (B) of the present invention is obtained. Properties are summarized in Table 1.

### Example 3

To the same reactor used in Example 1, 228 parts (1.0 mole) of bisphenol A as divalent phenol, 95 parts (1.03 mole) of epichlorohydrine and 200 parts of methylisobutyl ketone are added and dissolved at 40.□, then 25 parts (0.30 mole) of 48.5% NaOH aqueous solution is dropped by 1 hour, then preliminary reaction is carried out at 70.□ for 1 hour. Further, 60 parts (0.73 mole) of 48.5% NaOH aqueous solution is dropped by 1 hour, then reacted at 90.□ for 3 hours. After that, 350 parts of methylisobutylketon and 250 parts of water are added and dissolved, then the reactor is stood and water layer is removed. 0.8 parts (0.01 mole) of 48.5% NaOH aqueous solution is further dropped and reacted at 80.□ for 1 hour. Neutralized by phosphoric acid, washed by water and water layer is removed. After washed by water again and filtrated, methylisobutyl ketone is distilled off. Thus epoxy resin (C) of the present invention is obtained. Properties are summarized in Table 1.

### Example 4

To the same reactor used in Example 1, 200 parts (1.0 mole) of bisphenol F as divalent phenol, 97 parts (1.05 mole) of epichlorohydrine and 200 parts of methylisobutyl ketone are added and dissolved at 40.□, then 25 parts (0.30 mole) of 48.5% NaOH aqueous solution is dropped by 30 minutes, then preliminary reaction is carried out at 70.□ for 1 hour. Further, 57 parts (0.69 mole) of 48.5% NaOH aqueous solution is dropped by 1 hour, then reacted at 90.□ for 3 hours. After that, 350 parts of methylisobutylketon and 250 parts of water are added and dissolved, then the reactor is stood and water layer is removed. 4.1 parts (0.05 mole) of 48.5% NaOH aqueous solution is further dropped and reacted at 80.□ for 1 hour. Neutralized by phosphoric acid, washed by water and water layer is removed. After washed by water again and filtrated, methylisobutyl ketone is distilled off. Thus epoxy resin (D) of the present invention is obtained. Properties are summarized in Table 1.

### Comparative Example 1

To the same reactor used in Example 1, 228 parts (1.0 mole) of bisphenol A as divalent phenol, 102 parts (1.1 mole) of epichlorohydrine and 200 parts of methylisobutyl ketone are added and dissolved at 40.□, then 157 parts (1.18 mole) of 30% NaOH aqueous solution is dropped by 1 hour, then reacted at 90.□ for 3 hours. After that, 350 parts of methylisobutyl keton and 200 parts of water are added and dissolved, then the reactor is stood and water layer is removed. Neutralized by phosphoric acid, washed by water and water layer is removed. After washed by water again and filtrated, methylisobutyl ketone is distilled off. Thus epoxy resin (F) is obtained. The obtained resin is analyzed, and results indicate that epoxy equivalent is 1750 g/eq, phenolic hydroxyl group equivalent is 7000 g/eq, and amount of hydrolytic chlorine is 0.003 wt %.

### Comparative Example 2

To the same reactor used in Example 1, 228 parts (1.0 mole) of bisphenol A as divalent phenol, 97 parts (1.05 mole) of epichlorohydrine and 200 parts of methylisobutyl ketone are added and dissolved at 40.□, then 25 parts (0.30 mole) of 48.5% NaOH aqueous solution is dropped by 30 minutes, then preliminary reaction is carried out at 70. □ for 1 hour. Further, 57 parts (0.70 mole) of 48.5% NaOH aqueous solution is dropped by 1 hour, then reacted at 90.□ for 3 hours. After that, 350 parts of methylisobutylketon and 250 parts of water are added and dissolved, then the reactor is stood and water layer is removed. Neutralized by phosphoric acid, washed by water and water layer is removed. After washed by water again and filtrated, methylisobutyl ketone is distilled off. Thus epoxy resin (G) is obtained. The obtained resin is analyzed, and results indicate that epoxy equivalent is 1100 g/eq, phenolic hydroxyl group equivalent is 1200 g/eq, and amount of hydrolytic chlorine is 0.20 wt %.

### Comparative Example 3

Properties of conventional epoxy resin: EPOTOHTO YD-014 (product of Tohto Kasei Co., Ltd.) on the market, which is produced by a conventional direct synthesis of bisphenol A with epichlorohydrine, are summarized in Table 1.

### Comparative Example 4

Properties of phenolic curing agent: EPOTOHTO ZX-767 (product of Tohto Kasei Co., Ltd.) on the market, which is produced by an indirect synthesis of bisphenol A liquid epoxy resin with bisphenol A, are summarized in Table 1. TABLE-U.S. 00001

TABLE 1

| | | | | | Comp. | Comp. | Comp. | Comp. |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| Names of | A | B | C | D | F | G | YD-014 | ZX-767 |
| epoxy resin | | | | | | | | |
| and phenol | | | | | | | | |
| resin | | | | | | | | |
| Epoxy | 990 | 1550 | 1900 | 1620 | 1750 | 1100 | 960 | 250,000 |
| equivalent | | | | | | | | |
| (g/eq) | | | | | | | | |
| Phenolic | 1600 | 1940 | 1910 | 2020 | 7000 | 1200 | 50,000 | 375 |
| hydroxyl | | | | | | | | |
| group | | | | | | | | |
| equivalent | | | | | | | | |
| (g/eq) | | | | | | | | |
| Hydrolytic | 0.01 | 0.008 | 0.015 | 0.018 | 0.003 | 0.20 | 0.003 | 0.023 |
| chlorine | | | | | | | | |
| (wt %) | | | | | | | | |
| α diol * | 8 | 5 | 5 | 6 | 15 | 6 | 15 | 3 |
| meq/100 g) | | | | | | | | |
| X/Y □1 | 0.6 | 0.8 | 1.0 | 0.8 | 0.2 | 1.0 | 0.02 | 670 |

 1: epoxy equivalent (g/eq) Y: phenolic hydroxyl group equivalent (g/eq)

### Examples 5-8

To 100 parts of epoxy resins A˜D) obtained in Examples 1 to 4, 0.5 parts of 2-methylimidasole as a curing accelerator, 50 parts of titanium oxide as a white pigment, 0.5 parts of Acronal 4F (product of BASF) as a flow control agent and 0.5 parts of benzoin as an anti-popping agent are blended. These components for blending are blended in dry condition by a Henshell mixer, then fuse kneading is carried out 1 time using an extruder (product of lkegai Tekko; PCM-30) so as the temperature of resin to be 100-130° C., and after cooled down pulverized. Further, classified by a sieve of 100 mesh and powder coating is obtained. The obtained powder coating is coated on a mild steel plate, whose surface is treated by zinc phosphate, by electrostatic powder coating method and baked at 180° C. for 20 minutes, and a coated test piece having approximately 80 μm film thickness is obtained.

### Comparative Examples 5 and 6

By same blending ratio and by same operation to Examples 5, except changing epoxy resin to epoxy resin (F) and epoxy resin (G) obtained in Comparative Examples 1-2, powder coatings and coated test pieces are obtained.

### Comparative Example 7

By same blending ratio and by same operation to Example 5, except changing epoxy resin to EPOTOHTO YD-014, powder coating and coated test piece are obtained.

### Comparative Example 8

By same blending ratio and by same operation to Example 5, except changing epoxy resin to 74 parts of EPOTOHTO YD-014, further blending 26 parts of phenolic curing agent: EPOTOHTO ZX-767, powder coating and coated test piece are obtained.

### Comparative Example 9

By same blending ratio and by same operation to Example 6, except coarsely pulverized after first fuse kneading then carrying out 2.sup.nd fuse kneading by same condition, powder coating and coated test piece are obtained.

### Comparative Example 10

By same blending ratio and by same operation to Example 5, except changing epoxy resinto 74 parts of EPOTOHTO YD-014 of Comparative Example 3, further blending 2 parts of dicyandiamide (DICY) as a curing agent, powder coating and coated test piece are obtained.

Each test results are summarized in Table 2. For bending resistance test, a test piece of zinc phosphate treated cold rolled steel sheet of 0.3×50×150 mm size is used and for other tests a test piece of zinc phosphate treated cold rolled steel sheet of 0.8.□70.□150 mm size is used.

Evaluations are carried out according to following methods.

1) Adhesion; Evaluated by lattice pattern tape cutting test prescript in JIS K-5400. Clearance; 1 mm. Evaluation marks: perfect mark is 10.
2) Boiling water resistance; A test piece is soaked in boiling water for 4 hours, then the test piece is picked up and adhesion is evaluated.
3) Acid resistance; A test piece is soaked in 5% sulfuric acid for 30 days, then the test piece is picked up and adhesion is evaluated.
4) Alkali resistance; A test piece is soaked in 5% NaOH for 30 days, then the test piece is picked up and adhesion is evaluated.
5) Salt spray resistance; Cross cut is marked on a test piece and salt spray resistance test is carried out in accordance with JIS K-5400. After salt spray for 500 hours removed compulsorily using a cutter knife, one side removed width from cross cut part is measured. (◯; less than 1 mm, Δ; 1 mm or more and less than 3 mm, .□; 3 mm or more)

Test results by above mentioned 5 tests are averaged value of 3 test pieces.

Following 3 tests are carried out on 10 test pieces and numbers of test pieces on which defects are not observed is recorded. Perfect mark is 10.

6) Erichsen; Punch is pushed out by 10 mm using an Erichsen tester and crack or removing of coated film are visually inspected.
7) Shock resistance; According to JIS K-5400, measured by Dupont shock testing machine. A shot pattern of ¼ inch radius and a corresponding table are used and a weight of 1 kg is dropped from 50 cm height and crack or removing of coated film are visually inspected.
8) Bending resistance; According to JIS K-5400, evaluated by setting a core of 2 mm in diameter to a bending test machine. Crack or removing of coated film are visually inspected. 4

TABLE 2

| | | Example | | | | Comparative Example | | | | | |
|---|---|---|---|---|---|---|---|---|---|---|---|
| No. | | 5 | 6 | 7 | 8 | 5 | 6 | 7 | 8 | 9 | 10 |
| Name or epoxy resin and | A | 100 | — | — | — | — | — | — | — | — | — |
| phenol resin | B | — | 100 | — | — | — | — | — | — | — | — |
| | C | — | — | 100 | — | — | — | — | — | — | — |
| | D | — | — | — | 100 | — | — | — | — | — | — |
| | F | — | — | — | — | 100 | | — | — | — | — |
| | G | — | — | — | — | — | 100 | — | — | — | — |
| | YD-014 | — | — | — | — | — | — | 100 | 74 | 74 | 98 |
| | ZX-767 | — | — | — | — | — | — | — | 26 | 26 | — |
| | YDCN-704 | — | — | — | — | — | — | — | — | — | — |
| | DICY | — | — | — | — | — | — | — | — | — | 2 |
| X/Y 2 | | 0.6 | 0.8 | 1.0 | 0.8 | 0.2 | 1.0 | 0.02 | 0.9 | 0.9 | — |
| 2-methylimidasole | | 0.5 | 0.5 | 0.5 | 0.5 | 0.5 | 0.5 | 0.5 | 0.5 | 0.5 | 0.5 |
| titanium oxide | | 50 | 50 | 50 | 50 | 50 | 50 | 50 | 50 | 50 | 50 |
| Acronal 4F | | 0.5 | 0.5 | 0.5 | 0.5 | 0.5 | 0.5 | 0.5 | 0.5 | 0.5 | 0.5 |
| benzoin | | 0.5 | 0.5 | 0.5 | 0.5 | 0.5 | 0.5 | 0.5 | 0.5 | 0.5 | 0.5 |
| kneading times (times) | | 1 | 1 | 1 | 1 | 1 | 1 | 1 | 1 | 1 | 1 |
| adhesion | | 10 | 10 | 10 | 10 | 10 | 4 | 10 | 10 | 10 | 10 |
| boiling water resistance | | 8 | 10 | 10 | 10 | 8 | 0 | 10 | 6 | 10 | 0 |
| acid resistance | | 10 | 10 | 10 | 10 | 8 | 0 | 2 | 6 | 10 | 0 |
| alkali resistance | | 10 | 10 | 10 | 10 | 8 | 0 | 2 | 6 | 10 | 0 |
| salt spray test | | ◯ | ◯ | ◯ | ◯ | ◯ | X | Δ | X | ◯ | X |
| Erichsen | | 10 | 10 | 10 | 10 | 4 | 0 | 5 | 8 | 10 | 5 |
| shock resistance | | 9 | 10 | 9 | 10 | 0 | 0 | 0 | 5 | 8 | 5 |
| bending resistance | | 10 | 10 | 10 | 10 | 0 | 0 | 0 | 4 | 8 | 7 |

 2 X: epoxy equivalent after blended (g/eq) (calculated value) Y: phenolic hydroxyl group equivalent (g/eq) (calculated value)

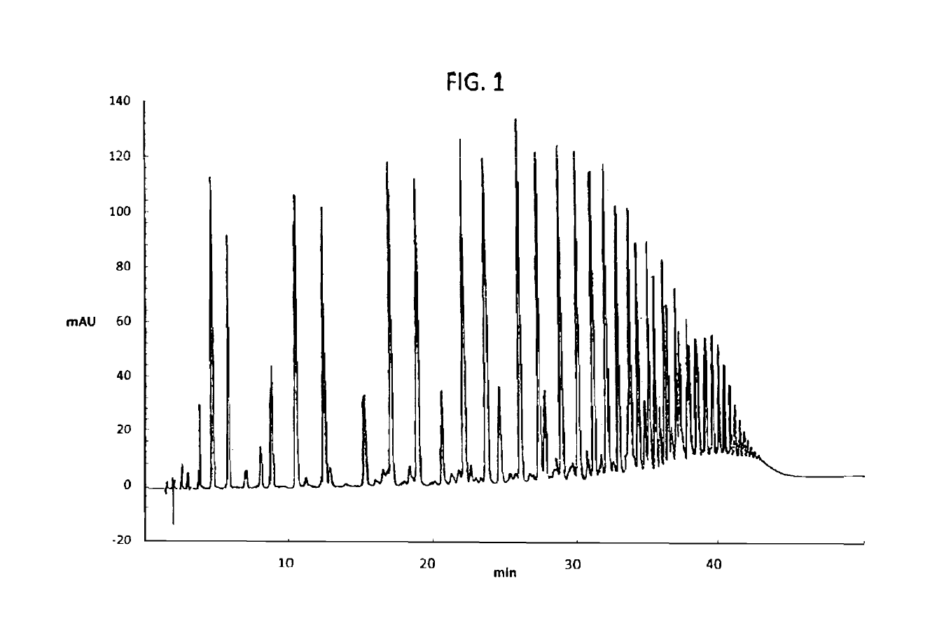

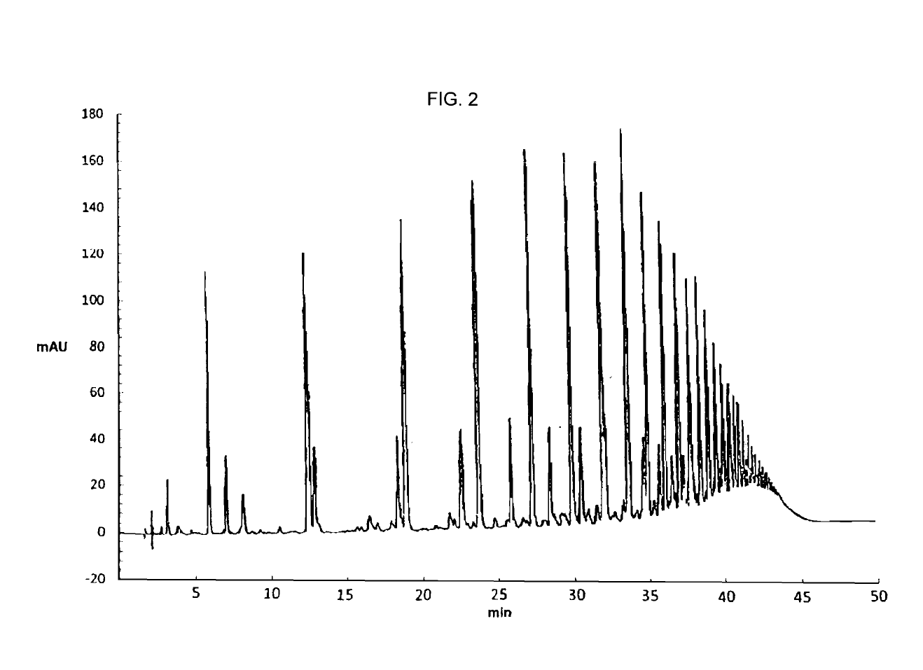

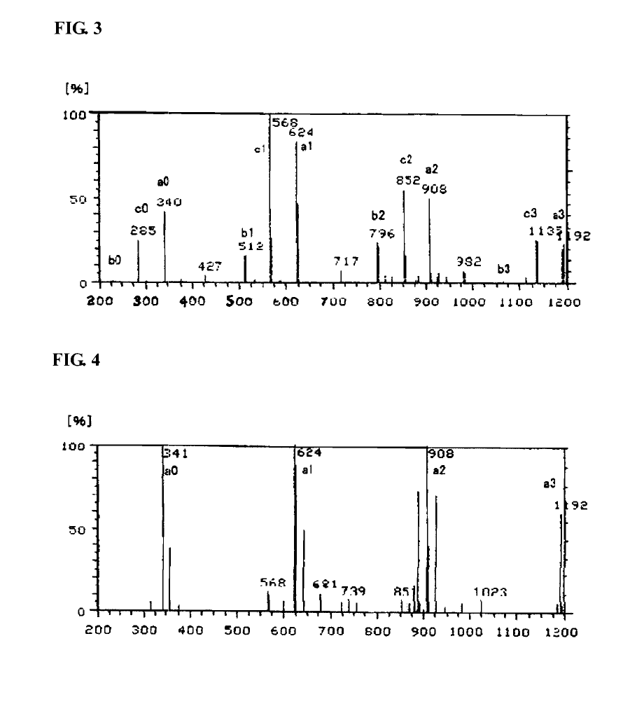

Regarding epoxy resin (B) obtained in Example 1 and epoxy resin (EPOTOHTO YD-014) of Comparative Example 1, HPLC chart and FD-MS spectrum are measured and results are shown in FIGS. 1-4.

### Measuring Method of HPLC Chart

### (Apparatus for Analyzing)

High performance liquid chromatography system of HEWLETT PACKARD: SERIES 1100
Detector: UV, detection wavelength: 280 nm
Column: Φ4.6 mm.□150 mm CD-C18 (product of Imtact) (Condition for Analyzation)
Mobile phase:
A solution: distilled water
B solution: tetrahydrofurane/acetonitlile=50/50 (ratio by volume)
Initial constitution: A solution/B solution=50/50 (ratio by volume)
Gradient (after 50 minutes): A solution/B solution=0/100 (ratio by volume)
Flow rate: 1 ml/minute
Adding volume: 5 μl
Column Temperature: 40.□ Measuring Method of FD-MS Spectrum
   Apparatus: Double-focusing mass spectrometer, Hitachi-80B
   Field desorption analyzing method (FD-MS)
   FD: Carbon emitter

### Resolvability: 1500

Magnetic field sweeping speed: m/z 0-1500/8.0 sec
Accelerating voltage: 3 kv
Emitter heating current: 0-35 mA/600 sec.
Magnetic field proofreading: perfluorokerosen (PFK) by EI ionization method is used.
Calibration curve: polyethylene glycol

### INDUSTRIAL APPLICABILITY

Epoxy resin of the present invention contains chemically-bonded phenolic hydroxyl group which is effective for curing, and is not necessary to produce epoxy resin and phenolic curing agent individually. Therefore, a problem caused by uneven mixing with a curing agent can be avoided, accordingly a cured product with very few defects can be obtained. A cured product obtained from epoxy resin composition of the present invention is characterized to reproduce a product having same properties such as adhesion, flexibility or shock resistance.

What is claimed is:

1. An epoxy resin represented by general formula (I), which satisfies numerical formula (1) mentioned below and comprises hydrolytic halogen of 0.05 wt. % or less, said epoxy resin being produced by the procedure as follows: after dissolving 1.03 to 1.10 mole of epihalohydrin to 1 mole of divalent phenol in a solvent, a pre-reaction is performed over 30 to 70 minutes by adding dropwise 0.25-0.35 mole of 30˜50% aqueous solution of alkali metal hydroxide over 30 to 70 minutes thereto, and thereafter, 0.65-0.75 mole of the remaining 30˜50% aqueous solution of alkali metal hydroxide is added dropwise over about 1 hour to complete the reaction over 1 to 3 hours. 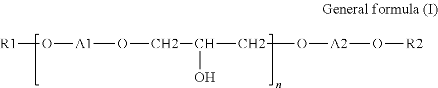
wherein n is an integer of 0 or more;
A₁ and A₂ are residue of divalent phenol, and can be same or different;
both R₁ and R₂ are H or 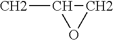
0.5≦X/Y≦1.5 Numerical formula (1)
wherein,
X: epoxy equivalent (g/eq);
Y: phenolic hydroxyl group equivalent (g/eq).

2. The epoxy resin of claim 1 wherein divalent phenols is bisphenols.

3. The epoxy resin of claim 1 wherein epoxy equivalent of the resin is 3000 g/eq or less and phenolic hydroxyl group equivalent of the resin is 5000 g/eq or less.

4. An epoxy resin composition comprising, containing epoxy resin according to claim 1 as an essential component.
